(19) United States
(12) Patent Application Publication
(10) Pub. No.: US 2011/0169766 A1
(43) Pub. Date: Jul. 14, 2011

(54) Detecting apparatus of a resistive touch panel

(75) Inventor: Hung-Yi Lin, Hsin Tien (TW)

(73) Assignee: IdeaCom Technology Corporation, Hsin Tien (TW)

(21) Appl. No.: 12/659,747

(22) Filed: Mar. 19, 2010

(30) Foreign Application Priority Data
Jan. 8, 2010 (TW) 099100425

(51) Int. Cl. G06F 3/045

(52) U.S. Cl. 345/174

(57) ABSTRACT

The invention relates to a detecting apparatus of resistive touch panel comprising a resistive touch panel and a plurality of sensing modules. The resistive touch panel includes a plurality of sensing blocks, each of which is composed of a first sensing unit and a second sensing unit. The plurality of sensing module with corresponding to the plurality of sensing blocks are used for detecting whether those sensing blocks have been touched by the user. Each of those sensing modules comprises a voltage source, an adjusting unit, a controlling unit and a sensing unit. The adjusting unit couples to the first sensing element for generating a current. The controlling unit selectively couples the second sensing element to ground terminal upon a controlling signal. The sensing unit detects a voltage of the adjusting unit and further determines whether the sensing block has been touched by the user or not upon the voltage.

### BACKGROUND OF THE INVENTION

1. Field of the Invention

The invention is related to a detecting apparatus of a resistive touch panel, and more specifically related to a detecting apparatus of a resistive touch panel for detecting multi touch executed on the resistive touch panel by a user.

2. Description of the Prior Art

With the significant improvements of touch sensitive technology in recent years and with great convenience in its use, a variety of touch sensitive technologies are generally used in many different kinds of electronic products. Among these, a touch panel is implemented in various kinds of electronic products because of its advantages in small size, less cost, low power consumption and durable life.

Accordingly, touch panels can be divided into resistive touch panels, capacitive touch panels, optical touch panels, various kinds of touch panels and etc. Conventional resistive touch panels can only detect single touch executed by the user because of the limitation of the structure therein. The resistive touch panel has the limitation in the application that it can't detect the multi touch executed by the user correctly.

Therefore, how to provide a detecting apparatus of a resistive touch panel for detecting multi touch executed by the user on the resistive touch panel becomes an important subject in the development of the resistive touch panel technology.

### SUMMARY OF THE INVENTION

A primary objective of the present invention is to provide a detecting apparatus of a resistive touch panel for detecting the multi touch operation and further to provide a new application for the resistive touch panel.

One embodiment of the present invention provides a detecting apparatus of a resistive touch panel comprising a resistive touch panel and a plurality of sensing modules. The resistive touch panel includes a plurality of sensing blocks, each of the plurality of sensing blocks comprising a first sensing element and a second sensing element. The plurality of sensing modules with corresponding to the plurality of sensing blocks are used for detecting whether the plurality of sensing blocks have been touched by the user or not, in which each of the plurality of sensing modules comprises a voltage source, an adjusting unit, a controlling unit and a sensing unit. The adjusting unit is coupled to the voltage source for generating a current according to the voltage source. The controlling unit is coupled to the second sensing element for selectively coupling the sensing unit to a ground terminal according to a controlling signal. The sensing unit coupled to the adjusting unit and the first sensing element is used for detecting a voltage of the adjusting unit and further determining whether the sensing block touched by the user or not according to the voltage of the adjusting unit.

In order to be more apparent to those skilled in the art from the above disclosure in the present invention as well as other objectives, features, advantages and thereof, the article below illustrates the preferred embodiment and makes more detailed description with corresponding to the accompanying figures as follows:

### BRIEF DESCRIPTION OF THE DRAWINGS

FIG. 1 is a schematic diagram of one embodiment of a resistive touch panel of a detecting apparatus of a resistive touch panel according to the present invention.

FIG. 2 is a schematic diagram of one embodiment of a sensing module of a detecting apparatus of a resistive touch panel according to the present invention.

FIG. 3 is a schematic diagram of a detecting apparatus of one embodiment of a resistive touch panel according to the present invention.

### DETAILED DESCRIPTION

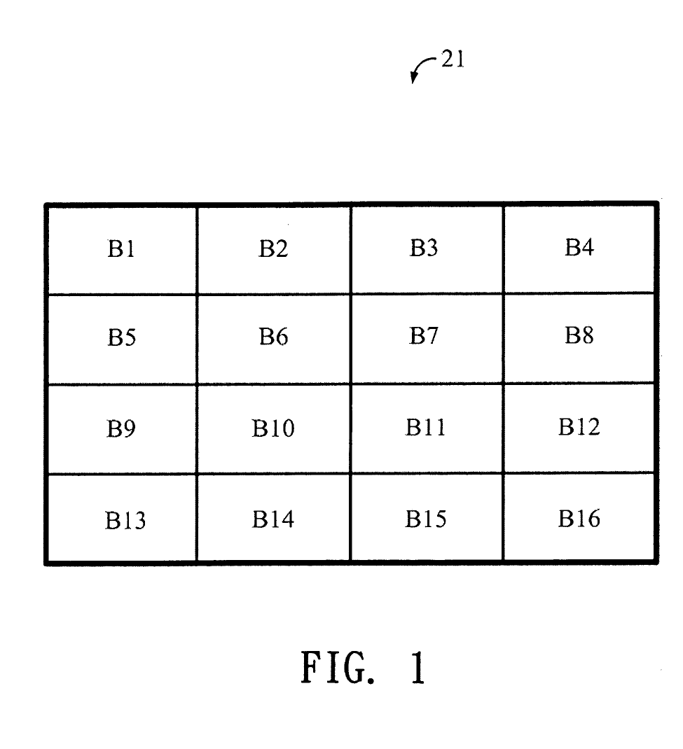

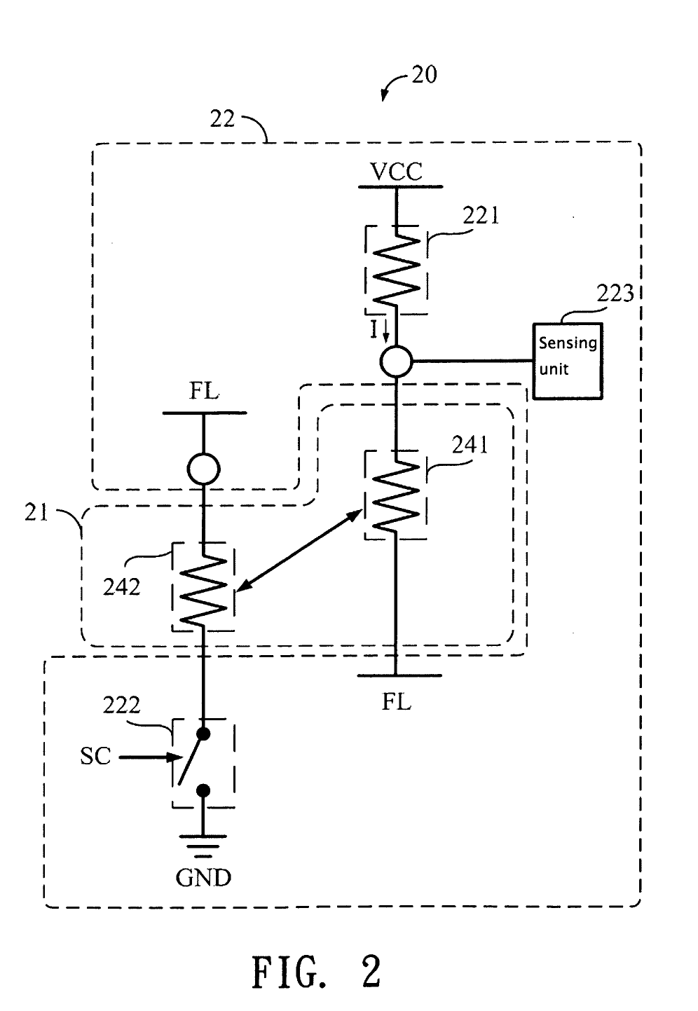

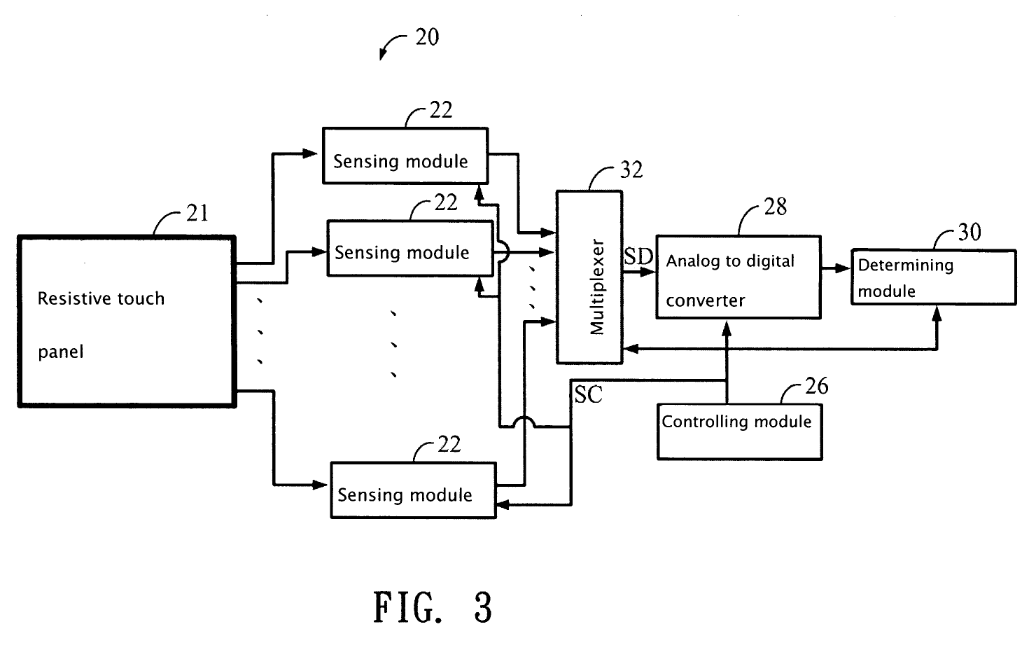

Please refer to FIGS. 1 to 3. FIG. 1 is a schematic diagram of one embodiment of a resistive touch panel of a detecting apparatus of a resistive touch panel according to the present invention. FIG. 2 is a schematic diagram of one embodiment of a sensing module of a detecting apparatus of a resistive touch panel according to the present invention. FIG. 3 is a schematic diagram of one embodiment of a detecting apparatus of a resistive touch panel according to the present invention. As shown in FIGS. 1 to 3, the present invention provides a detecting apparatus 20 of a resistive touch panel comprising a resistive touch panel 21 and a plurality of sensing modules 22. The resistive touch panel 21 includes a plurality of sensing blocks B1˜B16 (for example B1˜B16 as shown in FIG. 1, wherein FIG. 1 illustrates the resistive touch panel 21 including 16 sensing blocks), in which one of the plurality of sensing blocks B1˜B16 comprises a first sensing element 241 and a second sensing element 242. The plurality of sensing modules correspond to the plurality of sensing blocks B1˜B16 for detecting whether those sensing blocks have been touched by a user or not, respectively, wherein each one of the plurality of sensing modules 22 comprises a voltage source VCC, an adjusting unit 221, a controlling unit 222 and a sensing unit 223. The adjusting unit 221 coupled to the voltage source VCC is used for generating a current I according to the voltage source VCC. The controlling unit 222 coupled to the second sensing element 242 is used for coupling the second sensing element 242 selectively to a ground terminal GND according to a controlling signal SC. The sensing unit 223 coupled to the adjusting unit 221 and the first sensing element 241 is used for detecting a voltage of the adjusting unit 221 and further determining whether the sensing blocks B1˜B16 are touched by the user or not according to the voltage.

In one embodiment, the first sensing element 241, the second sensing element 242 and the adjusting unit 221 are a resistor, respectively. The controlling unit 222 is a switch used for controlling the second sensing element 242 to be coupled to the ground terminal GND according to the controlling signal SC. Furthermore, the other terminals of the first sensing element 241 and the second sensing element 242 are coupled to a floating potential FL.

Please continue referring to FIG. 1 and FIG. 2. As shown in FIG. 1 and FIG. 2, when the user touches the sensing blocks B1˜B16 of the touch panel 21, the first sensing element 241 and the second sensing element 242 are coupled to each other due to the press operation as the bi-directional arrow shown in FIG. 2. Therefore, the current I flows from the voltage source VCC, via the adjusting unit 221, the first sensing element 241, the second sensing element 242, the controlling unit 222 and finally to the ground terminal GND. Thus the voltage of the adjusting unit 221 changes from a first potential to a second potential. As long as the sensing unit 223 detects the voltage of the adjusting unit 221 changing from the first potential to the second potential, it determines which sensing block of B1˜B16 on the resistive touch panel 21 has been touched by the user. Further, execute the detection for the exact pressing position to get the exact pressing position to complete the function of whole detection of pressing position.

In one embodiment, the first sensing element 241 is interlaced to the second sensing element 242. The first sensing element 241 is disposed to be perpendicular to the second sensing element 242 approximately. Besides, the detecting apparatus 20 further comprises at least one controlling module 26, at least one analog to digital converter 28 and at least one determining module 30. The at least one controlling module 26 is coupled to the plurality of sensing modules 22 to generate the controlling signal SC. The at least one analog to digital converter 28 is coupled to the at least one controlling module 26 to convert a plurality of the detecting signal SD detected from the plurality of sensing blocks B1˜B16 according to the control of the at least one of controlling module 26. The at least one determining module 30 is coupled to the at least one analog to digital converter 28 to determine the position on which the sensing blocks B1˜B16 of the resistive touch panel 21 have been touched by the user according to the plurality of detecting signals SD after detection.

Moreover, the detecting apparatus 20 of the resistive touch panel 21 of the present invention further comprises at least one multiplexer 32 coupled to the at least one analog to digital converter 28.

As mentioned above, the detecting apparatus of the resistive touch panel divides the resistive touch panel into a plurality of sensing blocks. Each of the plurality of sensing blocks adopts the conventional structure of the resistive touch panel. Therefore, as long as the detecting apparatus 20 determines which sensing block has been touched by the user at first and then executes the detection and the determination of the position in detail for the sensiting block, one can get the pressing position of resistive touch panel which is pressed by the user. Because each of sensing blocks is independent to one another, the detecting apparatus of the resistive touch panel of the present invention may execute the detection of multi touch to improve that the conventional resistive touch panel can only detect single touch on it, and further provide more applications different from the conventional resistive touch panel.

Although the present invention has been disclosed above by the preferred embodiment, it is easily understood by those skilled in the art that various changes and modifications are possible without departing from the spirit and scope of the present invention. Thus, it is intended that the specification and examples be considered as exemplary only, with the true scope and spirit of the invention being indicated by the following claims.

What is claimed is:

1. A detecting apparatus of a resistive touch panel, comprising:
a resistive touch panel including a plurality of sensing blocks, each of the sensing blocks comprising a first sensing element and a second sensing element; and
a plurality of sensing modules corresponding to the plurality of sensing blocks for detecting whether the plurality of sensing blocks touched by a user or not, wherein each of the plurality of sensing modules comprises:
a voltage source;
an adjusting unit coupled to the voltage source and the first sensing element for generating a current according to the voltage source;
a controlling signal allowing the second sensing element to be selectively coupled to a ground terminal; and
a sensing unit coupled between the adjusting unit and the first sensing element for detecting a voltage of the adjusting unit, and further determining whether the sensing block touched by the user or not according to the voltage of the adjusting unit.

2. The detecting apparatus of a resistive touch panel of claim 1, wherein the first sensing element, the second sensing element and the adjusting unit are a resistor respectively.

3. The detecting apparatus of a resistive touch panel of claim 1, wherein the controlling unit is a switch used for selectively coupling to the second sensing element to the ground terminal by a controlling signal.

4. The detecting apparatus of a resistive touch panel of claim wherein the other terminals of the first sensing element and the second sensing element are coupled to a floating voltage.

5. The detecting apparatus of a resistive touch panel of claim wherein when the user touches the plurality of sensing blocks of the resistive touch panel, the first sensing element and the second sensing element are coupled to each other, the potential of the adjusting unit changes from a first potential to a second potential.

6. The detecting apparatus of a resistive touch panel of claim 1, wherein the first sensing element is interlaced to the second sensing element.

7. The detecting apparatus of a resistive touch panel of claim 6, wherein the first sensing element is disposed to be perpendicular to the second sensing element approximately.

8. The detecting apparatus of a resistive touch panel of claim 1, wherein the detecting apparatus further comprises:
at least one controlling module coupled to the plurality of sensing modules for generating the controlling signal;
at least one analog to digital converter coupled to the at least one controlling module to convert a plurality of detecting signals detected from the plurality of sensing blocks according to the control of the at least one of controlling module; and
at least one determining module coupled to the analog to digital converter to determine the position on which the resistive touch panel has been touched by the user according to the plurality of detecting signals after change.

9. The detecting apparatus of a resistive touch panel of claim 8, wherein the detecting apparatus further comprises at least one multiplexer coupled to the at least one analog to digital converter.
